(19) United States
(12) Patent Application Publication
(10) Pub. No.: US 2005/0220944 A1
(43) Pub. Date: Oct. 6, 2005

(54) Method and apparatus for preventing fluid collection in a high speed process for making food casings

(76) Inventors: Ivo Hendriks, Overpelt (BE); Ghislain Gielen, Peer (BE); Stefan D. Beckers, Eksel (BE)

Correspondence Address: FISH & RICHARDSON P.C., 1717 MAIN STREET, SUITE 5000, DALLAS, TX, 75201, US

(21) Appl. No.: 10/515,523

(22) PCT Filed: May 23, 2002
(86) PCT No.: PCT/GB02/02413

§ 371 Date: May 16, 2005

(51) Int. Cl. A23G 1/00

(52) U.S. Cl. 426/135

(57) ABSTRACT

A method for the preparation of a tubular food casing which comprises the steps of providing a flowable material which can be extruded to form a fluid treatable tubular film, upwardly extruding the flowable material through an extrusion die (10) to form a tubular film (15) and moving and maintaining the tubular film (15) in an upwardly inclined position while contacting said tubular film (15) with fluid.

This invention relates to methods and apparatus for making tubular food casings and more particularly relates to such methods and apparatus where coagulating, precipitating or wash liquid is introduced into the tube to stabilize it. Coagulating, precipitating or wash liquid (stabilizing liquid) is almost always introduced into the inside of the tubular food casing in the process of making such food casings from collagen suspensions, derivatized cellulose in solution, and non-derivatised cellulose in solution. In the case of collagen casing, suspending liquids, e.g. alkali, are neutralized and washed from extruded collagen tubes with acid solution and water. In the case of casings made from derivatized cellulose in solution (e.g. cellulose xanthate in carbon disulphide and caustic, i.e. viscose), cellulose is regenerated by contact with a mixture of a strong acid and a salt such as sodium sulfate. When food casing is made from non-derivatized cellulose in solution, e.g. a solvent including a tertiary amine oxide, the tertiary amine oxide solvent is washed from extruded casing with water to precipitate the cellulose. Numerous subsequent liquid treatments may be used, e.g. for further regeneration, precipitation, washing, plasticizing, release treatment, adherence treatment, colouring, flavouring, etc.

Until now, casing has usually been formed by extruding downwardly into a liquid bath or upwardly through a liquid bath where the liquid is required for treatment of the outside of the casing. Liquid for treatment of the inside of the casing is usually supplied through the centre of the extrusion die and is similarly removed through the centre of the extrusion die. Casing which is downwardly extruded, after initial liquid treatment, is placed over a transfer roller that directs the casing up out of the bath. The casing is then usually placed over a second roller that again directs the casing downwardly into a second bath. Similarly, casing which is upwardly extruded through a liquid bath, after initial liquid treatment, is placed over a transfer roller that directs the casing downwardly into a second bath. Numerous such baths may thus be placed in series with the casing travelling first downwardly into the bath and then upwardly out of the bath.

There has been a problem associated with the above process. In particular, treating liquid introduced into the interior of the casing in a downwardly moving leg i.e. through the centre of the extrusion die, initially remains in the downwardly moving leg but as the tube continues to pass over the roller, liquid is carried around the roller so that it collects in the subsequent upwardly moving leg and even further subsequent legs. Similarly, treating liquid introduced into the interior of the casing in an upwardly moving leg, i.e. through the centre of the extrusion die will be carried around the transfer roller so that it collects in the subsequent upwardly moving leg and even further subsequent legs. Eventually the collection in subsequent legs becomes so great that it interferes with processing of the casing, e.g. causing bulging, contaminating subsequent treating liquids, and in extreme cases even splitting the casing. There is unfortunately no way to remove undesired liquid from these subsequent legs without breaching the wall of the casing, e.g. by cutting. Such cutting is time consuming, wastes casing product and usually requires later splicing.

Further, it has been found that treatment liquids, for example casing wash liquids, can enter the casing cavity, which is believed to occur through an osmotic effect across the casing wall.

In accordance with the invention there is therefore provided a method and apparatus for food processing food casing that reduces and even may eliminate collection of undesirable liquid within the interior of the food casing.

In particular, downwardly directed legs during liquid treatment are eliminated. The result is that treating liquid is not present in a downwardly directed leg to form a liquid pressure against a transfer roller. Liquid thus does not easily pass the transfer roller to collect in a subsequent upwardly directed leg. In accordance with the present invention, all legs in steps that use a liquid to treat the interior or exterior of the tubular food casing are upwardly directed, e.g. at an upward angle of 5 to 90 degrees from horizontal.

More particularly, the invention comprises a method and apparatus for the preparation of a tubular food casing. The method comprises the steps of:
a) providing a flowable material which can be extruded to form a fluid treatable tubular film;
b) upwardly extruding the flowable material through an extrusion die to form a tubular film;
c) moving and maintaining the tubular film in an upwardly inclined position while contacting said tubular film with fluid.

Typically the flowable material is stabilized as a film following extrusion by treatment with a stabilizing liquid. The stabilizing liquid may be contacted with the inside surface of the freshly extruded tubular film by introduction through the extrusion die via a suitable entry port to congeal the interior surface of the tubular film. The stabilizing liquid is refreshed typically by removal through a suitable exit port or drain in the extrusion die.

The outer surface of the tubular film may be contacted with stabilizing liquid by moving the tube through a stabilizing liquid bath to congeal the external surface of the film. Alternatively liquid may be sprayed onto the exterior surface of the tubular film.

Conveniently the tubular film may be passed over one or more rollers to direct it along an upwardly inclined conduit for further external liquid treatment wherein liquid is introduced at, at least one point of the conduit and flows downwardly along the conduit and is collected at a point below the point of its introduction.

More than one liquid treating step as described above may be performed as desired. Typically, following liquid treatment the tubular film is subjected to a drying operation.

The apparatus comprises means for accomplishing the above steps.

The flowable material used to make the food casing may be essentially any flowable material that can be extruded with or without fibre reinforcement to form a tubular film and that can be congealed to stabilize the film by treatment with a stabilizing liquid. The flowable material may for example be a collagen suspension that can be extruded into a tubular film and be stabilized by treating with acid, for example by washing with an acidic solution. The flowable material may also, for example, be a solution of xanthate derivatized cellulose that can be extruded to form a tubular film and be stabilized by removing xanthate groups with a liquid containing an acid such as sulfuric acid along with a salt such as sodium sulfate. Steam may also be used to regenerate cellulose from a solution of xanthate derivatised cellulose. Another example of a suitable flowable material is a solution of non-derivatized cellulose in tertiary amine oxide and water that can be extruded to form a tubular film and be stabilized by washing with water or an aqueous solution of tertiary amine oxide to remove the amine oxide solvent.

Food casing that may be made by the present invention is essentially any tubular food casing that requires a liquid treatment subsequent to extrusion, or where liquid may form inside the casing, such as when the casing is treated with a gas or vapour such as steam. Such food casings are usually, but not always, tubular casings for meats, e.g. luncheon meats, hams and sausages such as hot dogs, salami, bologna, bratwurst and breakfast sausages.

The process and apparatus of the invention are particularly suited to food casings made from cellulose that may be either derivatized or non-derivatized. For ease of understanding, the description of preferred embodiments of the invention will, therefore, be primarily directed to food casings comprising cellulose. It is, however, to be understood that the method and apparatus of the invention may be applied to processes for making food casings from other materials, e.g. collagen.

Cellulose food casings for which the invention is applicable, includes both seamless and seamed type tubular food casings. The invention is also applicable to food casings that are unreinforced or reinforced, e.g. with fibre. In the case of fibre reinforced food casing, the reinforcing may be dispersed in fluid cellulose solution prior to extrusion or fluid cellulose solution may be applied to a fibre reinforcement to form a tubular film. The fibre reinforcement may be a woven or non-woven reinforcement, e.g. cellulose fibre paper. In the case of a fibre paper reinforcement, flat paper is usually formed into the shape of a tube and then impregnated with cellulose solution, e.g. viscose which binds the edges of the paper to seam the paper and retain a tubular shape. Fluid cellulose (flowable material) that is used to make a tubular cellulose food casing may be a solution of a derivatized cellulose, e.g. a solution of cellulose xanthate or a solution of cellulose aminomethanate. The fluid cellulose may also be a solution of non-derivatized cellulose, e.g. a solution of cellulose in a tertiary amine oxide such as N-methylmorpholine N-oxide or cellulose in a cuprammonium salt solution.

“Flowable material” as used herein means the solution of solids in a diluent used to make food casings, e.g. a solution of cellulose xanthate in aqueous sodium hydroxide (viscose), a solution of cellulose aminomethanate in aqueous sodium hydroxide, a solution of cellulose in aqueous tertiary amine oxide, or a dispersion of collagen fibers in water at an elevated pH. “Diluent” means the liquid portion of the flowable material, e.g. aqueous sodium hydroxide, aqueous tertiary amine oxide or water.

“Upwardly extruding” means that the extrusion from the extrusion die occurs so that the initially formed casing moves in an upward direction, i.e. at an upward angle from the horizontal, preferably at a upward angle from about 5 to 90 degrees. Extrusion is usually at a vertical angle, i.e. 90 degrees from the horizontal.

“Film stabilizing liquid” is the liquid used to stabilize the extruded film, e.g. acid and salt solution in the case where the flowable material is viscose, water where the flowable material is a solution of non-derivatized cellulose in amine oxide and water and acid solution where the flowable material is a suspension of collagen fibers. “Stabilize”, as used herein, means to give the film more physical strength and more resistance to dissolution or weakening in aqueous solutions of pH 3 to 12.

In accordance with the invention, film stabilizing liquid is initially introduced into the interior of the extruded film through the centre of the extrusion die so that liquid can be introduced to the interior of the tubular film without breaching the wall of the tubular film. For the same reason, used film stabilizing liquid is removed through the centre of the extrusion die. The film stabilizing liquid inside of the extruded tube stabilizes the interior surface of the extruded tube. During this interior stabilisation operation the tubular film is substantially vertical. Extruded tube may then be further moved through a bath of film stabilizing liquid to stabilize the exterior surface of the film. Preferably though, the tubular film is passed over a roller or belt positioned in an arc to direct it at an upward incline for further second external liquid treatment, e.g. further coagulation, stabilization and washing.

Use of an arc shaped belt is preferred. More space is needed for installation of a roller than for a belt having an arc defining part of a circle having the same diameter as a roller. Advantageously therefore a belt system is less cumbersome than an equivalent roller system. The arc shaped belt may define an arc of a circle or an arc of any other suitable shape. The belt tension may be varied and the belt preferably moves at the same speed as the tubular film resting on it.

The degree of curvature, that is, the diameter of the roller, or equivalent diameter in the case of an arc shaped belt, is chosen so that the tubular film resting thereon does not completely flatten. A positive pressure from liquid and/or gas within the tube maintains it in an open or partially open state. Larger diameter rollers or larger equivalent diameter arc shaped belts tend to mitigate flattening of the tube compared to smaller diameter rollers or equivalent diameter arc shaped belts.

The degree of tube inflation may however fluctuate. The tube may at times be completely deflated and at other times be fully inflated. This is known by the skilled artisan as puffing. Allowing the inclined tube to remain open or partially open either constantly or intermittently is important because liquid inside the tube is then able to move downwards through the tube to a drain point. A tube which is stressed, typically when a small diameter roller or belt is used will tend to flatten resulting in restricted liquid flow.

In accordance with a preferred embodiment of the invention, the second and subsequent treatments usually occur along an upwardly inclined conduit, e.g. a trough, wherein liquid is introduced at, at least one point and flows downwardly along the conduit and is collected at a point below the point of its introduction. Conveniently, the tube is supported by and upon the liquid stream which flows counter to the movement of the tube within the conduit. This reduces or even eliminates the need for tube transfer belts within the conduit because of reduced friction between the tube and the conduit.

To increase tubular film output production, more than one conduit, each containing an upwardly moving tubular film, may be provided. Typically such conduits are arranged parallel relative to each other. The liquid may be introduced to the conduit by any suitable means; however, in a preferred embodiment, liquid is sprayed over the exterior surface of the food casing and is collected at a lower end of the conduit for recycling or disposal. After the second treatment, the tubular food casing film may again be passed over a roller or arc shaped belt to direct it upwardly for further subsequent external liquid treatment. In a preferred embodiment from 4 to about 16 sequential liquid treatment steps occur while the tubular food casing is upwardly directed. Preferably at least six sequential liquid treatment steps occur after extrusion of the tubular film casing. “Sequential” as used in this context means that the treatment steps occur one right after the other without having the casing move in a downward direction. As many subsequent liquid treatments as desired may be accomplished by again directing the tubular food casing film in an upward direction over a further roller or arc shaped belt. The upward direction of travel of the tubular film food casing may be reversed with each treatment desired. For example, if the prior treatment occurred at an upward angle of between plus 5 and plus 60 degrees from the horizontal, the subsequent treatment will also usually occur at between plus 5 and plus 60 degrees from the horizontal but the direction of travel will be in a different plane, i.e. in a plane which intersects the plane of travel in the prior treatment. In an alternative embodiment, which is preferred, the upward direction of travel of the tubular film food casing is not reversed, but is allowed to continue along the conduit in a substantially linear path at an upward angle of between plus 5 and plus 60 degrees from the horizontal during liquid treatment steps or treatment steps where liquid may form within the tube interior.

In addition to external liquid treatments, the inside of the casing may also be subsequently treated after the first internal stabilization liquid treatment. Such subsequent internal liquid treatment steps also occur as casing moves upwardly. In such cases small upward angles from the horizontal are desirable, e.g. preferably from at least about 5 degrees and preferably less than 20 degrees and most preferably less than 10 degrees, since such small angles reduce the hydrostatic pressure of liquid inside of the casing thus reducing casing deformation (bulging) or rupture. The reducing hydrostatic pressure occurs because there is less rise per unit length of casing passing through the treatment steps than if the same length of casing in the treatment step rose at a steeper angle. The head pressure against the casing wall is thus reduced.

Such subsequent internal liquid treatments are done by means of “slugs” or “bubbles” of treating liquid placed within the casing, either through the first formed open end of the casing or by breaching the casing wall. Liquid may be placed inside of the casing by severing it, placing liquid into the interior of the casing through a severed end and then splicing the severed ends. Liquid may also be passed into the casing through a slit in the casing wall or by introduction through a small opening as might be made by a syringe. Such slits or openings are usually subsequently removed, e.g. by cutting the slit or opening from the casing and forming a splice between the severed ends. Such breaches in the casing wall, while essential for subsequent internal treatments, cause production slowdowns utilize manpower and result in loss of material.

In accordance with one aspect of the present invention, such breaches in the casing wall are less frequently required because treating liquid in the slug or bubble is not readily and undesirably transferred around a transfer roller to a subsequent leg. The liquid in the slugs or bubbles thus last longer.

The following specific examples relating to the manufacture of regenerated cellulose tubular film food casing serve to illustrate and not limit the present invention, with reference to the accompanying drawings in which:

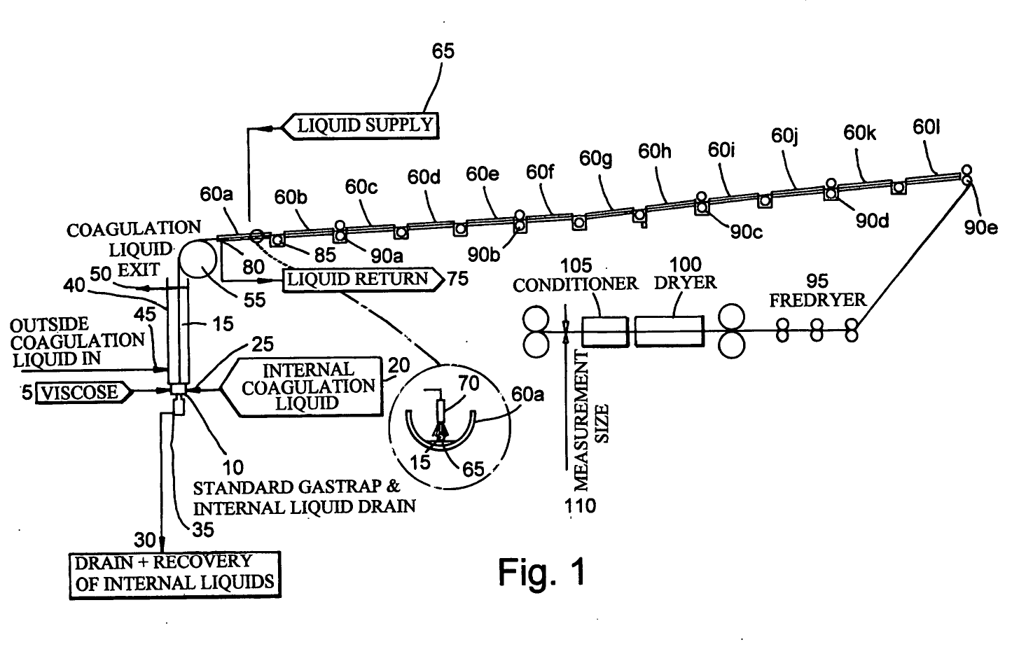

FIG. 1 is a schematic cross sectional representation of an apparatus and tubular cellulose film in combination in accordance with preferred embodiment of the present invention.

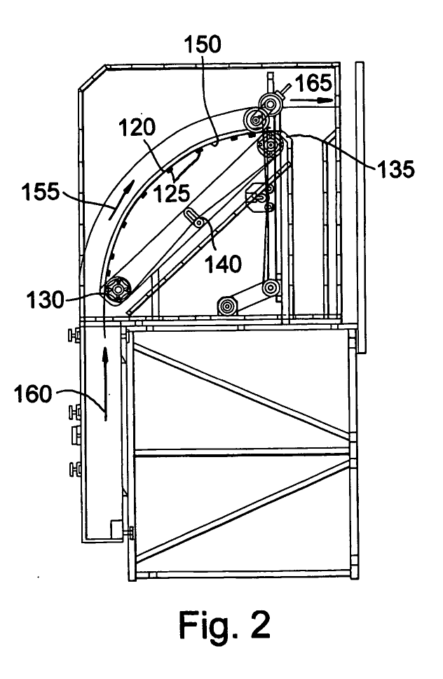

FIG. 2 is a schematic cross sectional representation of a belt which is supported to form and arc shape.

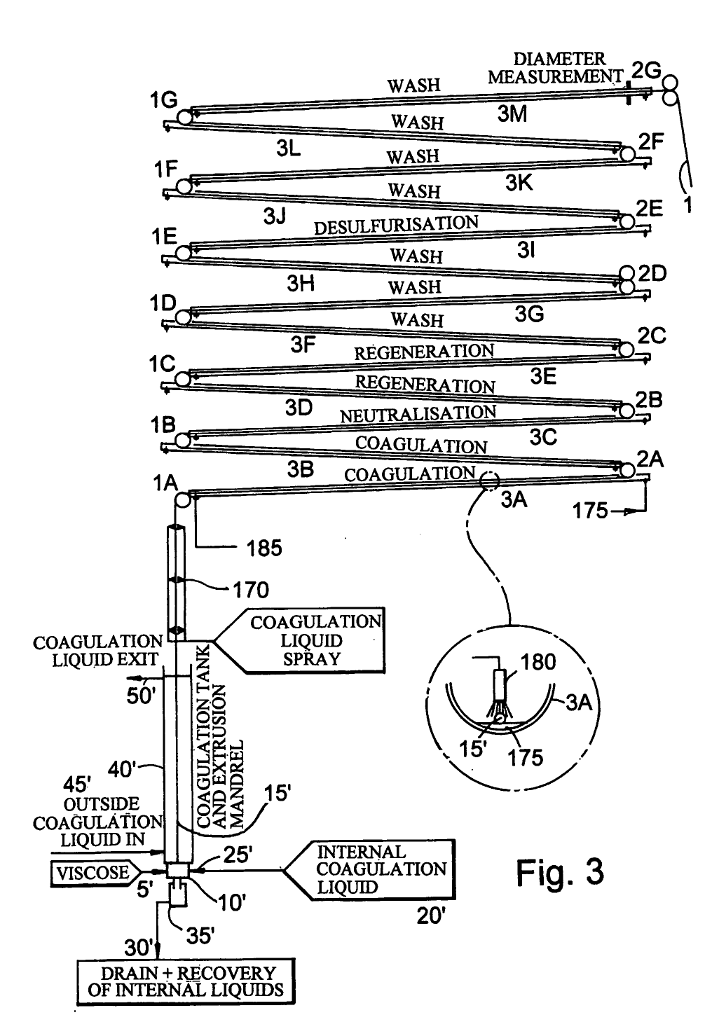

FIG. 3 is a schematic cross sectional representation of an apparatus and tubular cellulose film in combination in accordance with preferred embodiment of the present invention.

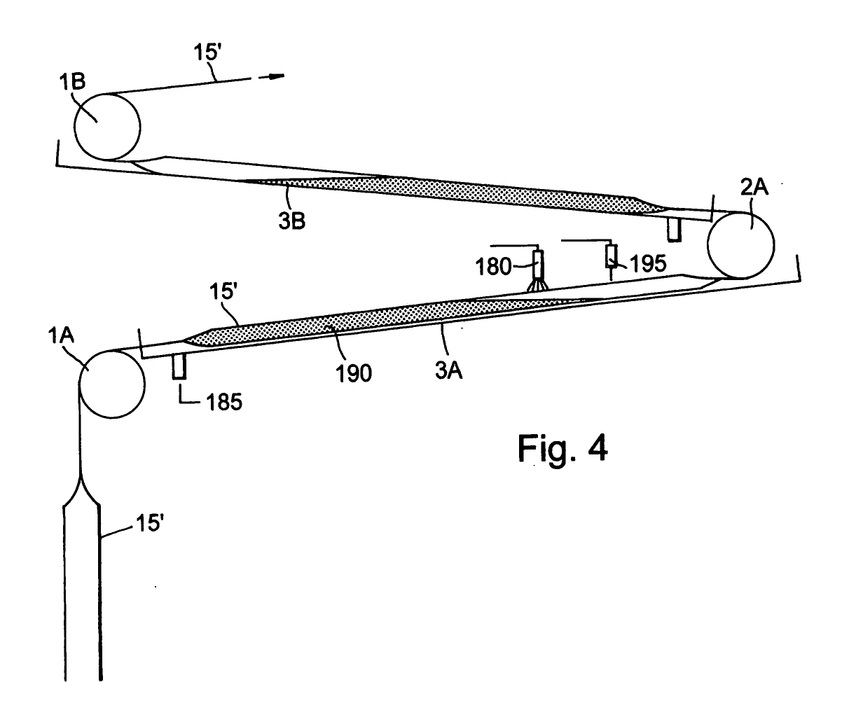

FIG. 4 is a schematic cross sectional representation of an enlarged portion of the apparatus shown in FIG. 3.

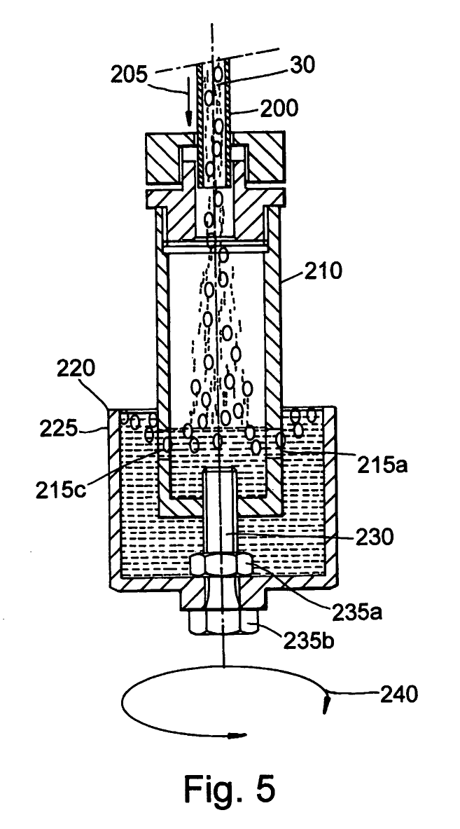

FIG. 5 is an enlarged schematic cross sectional representation of the drain port 35/35′ of FIGS. 1 and 3.

Referring to FIG. 1, viscose 5 enters extrusion die 10 and is upwardly extruded into a tubular film 15. Film stabilization or coagulation liquid 20 enters die 10 at port 25 to be introduced into the interior of tubular film 15 through extrusion die 10. Used coagulation liquid 30 is removed through the centre of die 10 at the drain port 35.

As best seen in FIG. 5, the used coagulation liquid 30 drains from the centre of die 10 through tube 200 in the direction indicated by arrow 205 into a second tube 210. Tubes 200 and 210 are immovably fixed to each other. Four holes 215a-215d (holes 215b and 215d not indicated) are positioned at the lower end of tube 210 at angles of 90° spaced apart positions to each other. Tube 210 is positioned such that holes 215a-215d are below lip 220 of cup 225. Through the lower end of tube 210 is threaded bolt 230 which is fixedly attached to cup 225 at its lower end by nuts 235a and 235b. The relative positions of tube 210 and cup 225 can be changed in a vertical manner by rotating cup 225 in either a clockwise or anti-clockwise direction as indicated by arrow 240. In operation, used coagulation liquid 30 exits tube 210 through holes 215a-215d into cup 225 and overflows lip 220. In this particular example, a difference in height between the liquid levels in tube 210 and cup 225 exists, and is indicated by a capital H. The hydrostatic pressure of coagulation liquid within the extruded casing and associated tubular apparatus may be changed by altering the position of cup 225 with respect to holes 215a-215d in tube 210 by rotating cup 225 to alter the height difference H.

Extruded tube 15 is moved upwardly through coagulation treating liquid bath 40 to stabilize the exterior surface of the tubular film. Coagulation liquid enters bath 40 at port 45 and used coagulation liquid exits bath 40 at port 50. Extruded tube 15 continues to move upwardly and then passes over roller 55 to direct it upwardly along upwardly inclined conduit 60a for further treatment by liquid 65. Further treating liquid 65 is sprayed onto tubular film 15 in conduit 60a by means of nozzle 70. Used treating liquid 75 then flows downwardly along conduit 60a to exit at orifice 80 for recycling or disposal.

After passing along conduit 60a the tubular film casing is then passed over roller 85 and directed upwardly along upwardly inclined conduit 60b for further treatment by a neutralisation treating liquid in a manner similar to the treatment described with respect to treatment in conduit 60a. The casing is progressed upwardly through the conduits 60b-60l for further liquid treatments as generally described with respect to conduit 60a by means of nip rollers 90a-e which are programmed to open and close in a sequential fashion so the downward flow of treatment liquid is not stopped at the nip rollers. Alternatively, the nip rollers can be grooved set to a small gap to allow gas and liquid inside the tube to pass through while still ensuring the tube is moved along the conduit. Further treatments may for example be neutralisation in conduit 60b. Further coagulation or regeneration in conduits 60c and 60d and washing in conduits 60e-60k; finishing in plastification in conduit 601.

The tubular film then passes through nip rollers 90e from where it is directed to a pre-drying area designated 95 before passing to a dryer 100, conditioner 105 and size measurement 110.

The roller 55 which passes the tubular film into the first coagulation conduit 60a may be substituted with an arc shaped belt which is herein described below with reference to FIG. 2. The belt 120 is supported to form an arc shape by a PTFE curved table 150 which is supported by struts 125. Rollers 130 and 135 allow the belt 120 to progress across table 150. A tensioning roller 140 is provided to ensure the belt 120 remains in contact with table 150. The direction of movement of belt 120 across table 150 is indicated by arrow 155. As indicated by arrow 160, tubular film passes upwardly and contacts with the belt 120. The belt 120 and tubular film move at the same speed during their contact and the tubular film then leaves belt 120 to pass onto further upwardly inclined processing as indicated by arrow 165.

The production method as described with reference to FIG. 1 is particularly advantageous over previous tubular casing production facilities for a number of reasons. Importantly manufacturing costs can be reduced because waste material is kept to a minimum because internal liquid removal by cutting the casing, draining, resealing and eventually removing-the resealed sections is avoided. Furthermore the process results in a reduced water content in the casing, and so a chemical de-watering system is not needed to remove the excess water within the casing material. Importantly because less drying is needed, higher tubular film speed can be used with existing drying equipment to give tubular film having the same water content as obtained by previous process.

Additionally, because the casing moves within the upwardly inclined conduits on a cushion of treatment liquid, no tube support and carrying belts are required thus simplifying tube production, and since the liquid, both externally and internally, flows in a counter direction to the tubular film, improved washing efficiency is obtained. Further, the internal and external wash liquids can be collected separately because the internal liquid drains via the extrusion die while the external liquid drains at suitably placed ports in the conduits.

The degree of stretch of the tubular film in the direction of movement can be controlled by adjusting the speed of the nip rollers or pick-up rollers. Furthermore, the variation in the degree of tube size, e.g. diameter, is reduced because internal liquid is continuously removed thereby keeping the internal liquid pressure more constant than in previous processes where liquid collects by backing up until the tube is cut to drain the liquid away; such previous processes tend to generate an increase in tube diameter as internal liquid builds up. The diameter is then reduced to its starting size when cutting takes place.

Referring now to FIG. 3, viscose 5′ enters extrusion die 10′ and is upwardly extruded into a tubular film 15′. Film stabilization or coagulation liquid 20′ enters die 10′ at port 25′ to be introduced into the interior of tubular film 15′ through extrusion die 10′. Used coagulation liquid 30′ is removed through the centre of die 10′ at the drain port 35′. Extruded tube 15′ is moved upwardly through coagulation treating liquid bath 40′ to stabilize the exterior surface of the tubular film. Coagulation liquid enters bath 40′ at port 45′ and used coagulation liquid exits bath 40′ at port 50′. Extruded tube 15′ continues to move upwardly and is externally sprayed with additional coagulation liquid by nozzles 170. Tube 15 then passes over roller 1A to direct it upwardly along upwardly inclined conduit 3A for treatment by liquid 175. Further treating liquid 175 is sprayed onto tubular film 15′ in conduit 3A by means of nozzle 180. Treating liquid 175 then flows downwardly along conduit 3A and exits at orifice 185 for recycling or disposal.

As best seen in FIG. 4, treating liquid may also be introduced into the interior of tubular film casing 15′ for liquid treatment by an internal bubble 190 of treating liquid as the casing passes upwardly along conduit 3A. Such introduction, may, for example, be done through an insertable needle 195. The bubble flows downwardly so that its bottom is at roller 1A that prevents further downward flow. The bubble 190 does not reach roller 2A thus no significant treating liquid in bubble 190 is transferred around roller 2A along upwardly directed conduit 3B.

After passing along conduit 3A, the tubular film casing is then passed over roller 2A and directed upwardly along conduit 3B for further treatment by a treating liquid in a manner similar to the treatment described with respect to treatment in conduit 3A. The casing is then redirected by rollers 1B, 2B, 1C, 2C, 1D, 2D, 1E, 2E, 1F, 2F and 1G along further conduits 3C, 3D, 3E, 3F, 3G, 3H, 3I, 3J, 3K, 3L and 3M for further subsequent liquid treatments as generally described with respect to treatment in conduit 3A. Treatments may for example be further coagulation in conduits 3A and 3B; neutralisation in conduit 3C; further regeneration in conduits 3D and 3E; washing in conduits 3F, 3G and 3H; desulfurisation in conduit 3I; and further washing in conduits 3J, 3K, 3L and 3M. At the end of conduit 3M, tubular film 15′ passes through squeeze rollers 2G to be directed for further treatment, e.g. plasticizing and drying. Alternatively plasticizing may be done before the tubular film 15′ passes through squeeze rollers 2G, where thereafter it is directed for drying.

The foregoing examples are understood not to limit the present invention, for example the number of wash or treatment steps may be varied as appropriate and hot wash or treatment liquids may be used. The wash flumes may also be enclosed by suitable means, for example a cover to reduce evaporation of treatment or wash liquids.

1. A method for the preparation of a tubular food casing which comprises the steps of:
a) providing a flowable material which can be extruded to form a fluid treatable tubular film;
b) upwardly extruding the flowable material through an extrusion die to form a tubular film;
c) moving and maintaining the tubular film in an upwardly inclined position while contacting said tubular film with fluid,
wherein all legs in steps that use a fluid to treat the interior or exterior of the tubular casing are upwardly directed; and
wherein said fluid may exit from said inside surface of said tubular film by removal through an exit port housed in said extrusion die.

2. The method of claim 1, wherein said fluid is a film stabilizing liquid.

3. The method of claim 2, wherein said liquid is contacted with the inside of said tubular film.

4. The method of claim 2 wherein said stabilizing liquid is contacted with the outer surface of said tubular film.

5. The method of claim 4, wherein said liquid is sprayed onto the outer surface of said tubular film.

6. The method of claim 2 wherein said tubular film is passed over one or more rollers to direct it in an upwardly inclined position.

7. The method of claim 2 wherein said tubular film is passed over one or more arc shaped belts to direct it in an upwardly inclined position.

8. The method of claim 6, wherein said film is directed along upwardly inclined conduits.

9. An apparatus for preparing tubular film providing the means for:
a) allowing a flowable material to be extruded to form a fluid treatable tubular film;
b) upwardly extruding the flowable material;
c) moving and maintaining the tubular film in an upwardly inclined position while said tubular film is contacted with fluid; and
d) removal of said fluid from said inside surface of said tubular through an exit port house in said extrusion die.

10. The method of claim 7, wherein said tubular film is directed along upwardly inclined conduits.

11. The method of claim 1, wherein all legs in steps that use a fluid to treat the interior or exterior of the tubular casing are upwardly directed at an upward angle of 5 to 90 degrees from horizontal.

12. The method of claim 1, wherein the flowable material comprises a solution of xanthate derivatized cellulose.

13. The method of claim 1, wherein the flowable material comprises a collagen suspension.

14. The method of claim 1, wherein the flowable material comprises a solution of non-derivatized cellulose in tertiary amine oxide and water.

15. The method of claim 12, wherein the fluid comprises an acid and a salt.

16. The method of claim 12, wherein the fluid comprises steam.

17. The method of claim 15, wherein the fluid comprises sulfuric acid and sodium sulfate.

18. The method of claim 13, wherein the fluid comprises acid.

19. The method of claim 14, wherein the fluid comprises water.

20. The method of claim 14, wherein the fluid comprises an aqueous solution of tertiary amine oxide.

21. The method of claim 12, wherein the tubular film is reinforced with fibre.

22. The method of claim 1, wherein at least four treatment steps occur while the tubular film is upwardly inclined.
